(19) United States
(12) Patent Application Publication
(10) Pub. No.: US 2022/0300788 A1
(43) Pub. Date: Sep. 22, 2022

(54) EFFICIENT COMPRESSION OF ACTIVATION FUNCTIONS

(71) Applicant: QUALCOMM Incorporated, San Diego, CA (US)

(72) Inventors: Jamie Menjay LIN, San Diego, CA (US); Ravishankar SIVALINGAM, San Jose, CA (US); Edwin Chongwoo PARK, San Diego, CA (US)

(21) Appl. No.: 17/207,406

(22) Filed: Mar. 19, 2021

(51) Int. Cl. G06N 3/04; G06N 3/08

(52) U.S. Cl. CPC G06N 3/0481; G06N 3/08; G06N 3/063

(57) ABSTRACT

Certain aspects of the present disclosure provide a method for compressing an activation function, comprising: determining a plurality of difference values based on a difference between a target activation function and a reference activation function over a range of input values; determining a difference function based on the plurality of difference values; and performing an activation on input data using the reference activation function and a difference value based on the difference function.

### INTRODUCTION

Aspects of the present disclosure relate to machine learning, and in particular to compression of activation functions for machine learning models.

Machine learning is generally the process of producing a trained model (e.g., an artificial neural network), which represents a generalized fit to a set of training data that is known a priori. Applying the trained model to new data enables production of inferences, which may be used to gain insights into the new data.

As the use of machine learning has proliferated for enabling various machine learning (or artificial intelligence) ptasks, the need for more efficient processing of machine learning model data has arisen. Given their computational complexity, machine learning models have conventionally been processed on powerful, purpose-built computing hardware. However, there is a desire to implement machine learning tasks on lower power devices, such as mobile device, edge devices, always-on devices, Internet of Things (IoT) devices, and the like. Implementing complex machine learning architectures on lower power devices creates new challenges with respect to the design constraints of such devices, such as with respect to power consumption, computational efficiency, and memory footprint, to name a few examples.

Accordingly, systems and methods are needed for improving the efficiency of machine learning model processing.

### BRIEF SUMMARY

Certain embodiments provide a method for compressing an activation function, comprising: determining a plurality of difference values based on a difference between a target activation function and a reference activation function over a range of input values; determining a difference function based on the plurality of difference values; and performing an activation on input data using the reference activation function and a difference value based on the difference function.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example process for compressing activation functions.

FIG. 2 depicts an example process for decompressing and using decompressed functions.

FIG. 3 depicts an example of determining a difference function based on a target activation function and a reference activation function.

FIG. 4 depicts a comparison of a target activation function, a quantized target activation function, and a compressed target activation function.

FIG. 5 depicts an example of a determining a step difference function based on a difference function.

FIG. 6 depicts an example of an antisymmetric difference function.

FIG. 7 depicts an example method for compressing an activation function.

FIG. 8 depicts an example processing system that may be configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and non-transitory computer-readable mediums for efficient compression of machine learning model activation functions.

Nonlinear activation functions are essential building blocks of machine learning models, such as neural networks. For example, several widely-used activation functions, such as Sigmoid, hyperbolic tangent (Tanh), Swish, and their “hardened” variants, are critical in the execution and performance of contemporary machine learning model architectures.

Run-time or real-time computation of common activation functions can be highly demanding. For example, the definition of a Swish activation function is Swish(x)=(xe^{x})/(1+e^{x}), which thus involves evaluation of the continuous function e^{x}, multiplication between x and e^{x}, and division—all of which incur relatively high computational cost. Because run-time evaluations of these functions needs to be performed many times on entries of an input tensor, they constitute a high computational complexity (e.g., measured in floating point operations per second or FLOPS) aspect of machine learning model architectures.

Consequently, many popular activation functions are beyond the capabilities of certain classes of devices, such as various mobile device, edge devices, always-on devices, Internet of Things (IoT) devices, and the like. Such devices may therefore be unable to process popular activation functions at run-time, and thus may not be able to leverage state-of-the-art machine learning model architectures.

One approach to address this issue is to pre-compute activation functions given hypothetical inputs and store all corresponding outputs in memory (e.g., in a look-up table). This approach avoids the run-time computation issue for computationally complex activation functions; however, storing these functions' outputs in memory also requires significant memory capacity and significant memory accesses, which drives up the size and cost of devices and increase power use and latency of devices.

In order to overcome the aforementioned technical problems, aspects described herein relate to differential compression and decompression techniques that leverage the small differences between pairs of similar, but different activation functions. As described herein, a target activation function is generally a more complex activation function compared to a reference activation function, which is similar in output, but less computationally complex to evaluate.

Where a reference activation function is suitably similar to a target activation function, the target activation function may be effectively “compressed” by encoding differences between the functions' output values over a range of input values and then using the computationally less complex reference function and the encoded differences to reconstruct the target function in real-time (or run-time). In this regard, compressing the target activation function refers to the ability to store less data using the determined differences than, for example, a look-up table of raw pre-computed values for the target activation function. However, lossy and lossless compression and decompression schemes may further be applied to the difference values. In some cases, the encoded differences may be referred to as a difference function between the target function and the reference function. Further, the target activation function may be considered compressed or encoded by the encoding and storing the differences between it and the reference activation function, and then decompressed or decoded when using the reference activation function and encoded differences to reconstruct it.

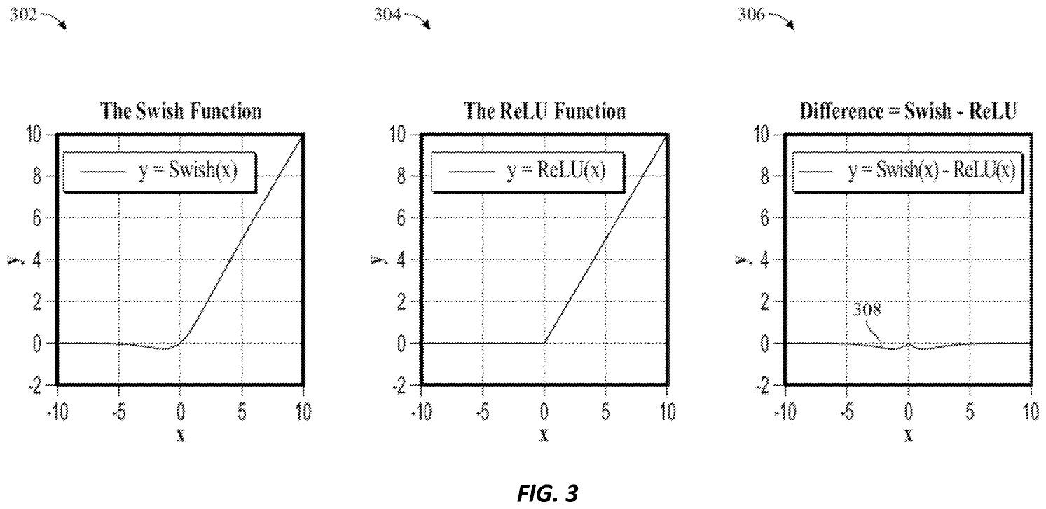

Because the encoded differences between the target and reference activation functions generally have a much smaller dynamic range than the target and reference activation functions' original outputs, encoding the differences is more memory space efficient than encoding pre-computed function values over a given range, as depicted in the examples of FIGS. 3, 4, and 6. A smaller memory footprint beneficially reduces power use, memory space requirements, and latency when reading the smaller values out of memory. Further, because less memory space is needed, memory may optionally be placed closer to the processing unit, such as in the case of a tightly-coupled memory, which further reduces latency. These benefits may be particularly useful in the context of low-power devices having limited processing and memory resources, such as always-on sensors, IoT devices, augmented reality devices (e.g., glasses), virtual reality devices (e.g., head-mounted displays), extended reality devices, and the like.

When a difference function based on a target activation function and reference activation function is symmetric or antisymmetric about a reference input value, then the difference function may be further compressed by storing only one half of the range (e.g., on either side of the reference input value). This works because the other half of the range, which is not stored, can easily be reconstructed based on the stored portion given the symmetry or anti-symmetry. In other words, the differences between the target and reference activation functions may first be encoded and then the symmetry or anti-symmetry of the differences may be exploited so only half of the difference function is required to be stored. The aforementioned benefits are thus enhanced in such situations.

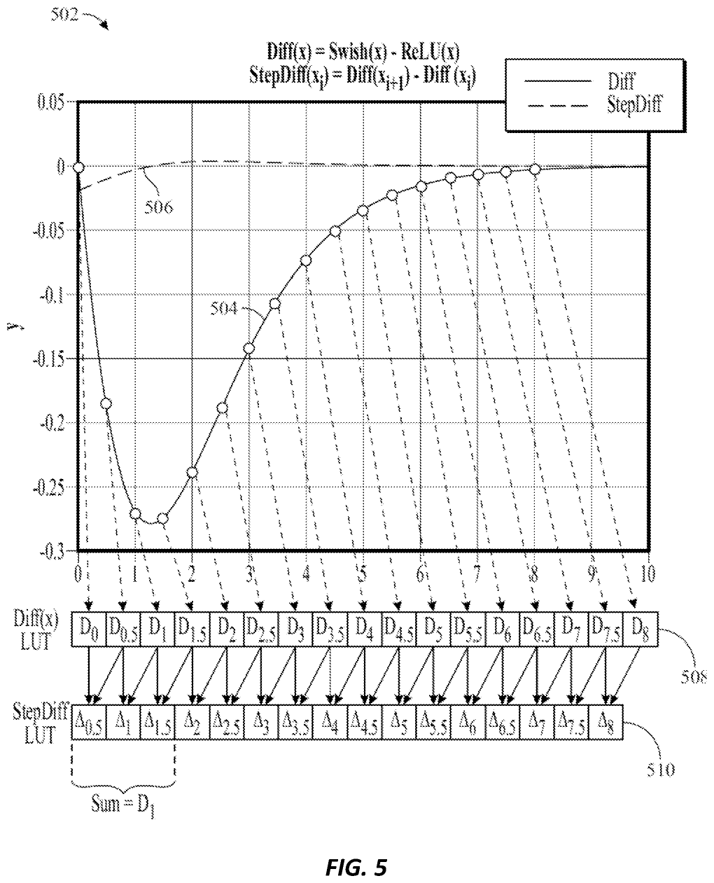

Further aspects relate to compression of a difference function based on differences between encoded difference values, which may be referred to as step differences. For example, where a difference function is quantized over a number of steps, the difference between the difference function values in two adjacent steps may be used to further compress the difference function. In such cases, the total difference value that is used in conjunction with a reference activation function may be determined iteratively by stepping from an initial difference value to a target difference value and aggregating the step difference at every step, thereby reconstructing the compressed difference function. An example of a step difference function is described with respect to FIG. 5.

Aspects described herein apply to a wide variety of functions used for machine learning, and in particular to popular activation functions, as well as a wide variety of processing types, including floating-point processing (e.g., as performed efficiently by GPUs) and fixed-point processing (e.g., as performed efficiently by neural signal processors (NSPs), digital signal processors (DSPs), central processing units (CPUs), application-specific integrated circuits (ASICs), and the like).

Aspects described herein may be applied to any target and reference function that are sufficiently similar. Various example described herein relate to popular activation functions, including the Sigmoid activation function with form:

Sigmoid(x)=e^{x}/1+e^{x},

the Tanh activation function with form:

Tanh(x)=sinh(x)/cosh(x)=e^{x}−e^{-x}/e^{x}+e^{-x}=e^{2x}−1/e^{2x}+1,

and the Swish activation function with form:

Swish(x)=x*Sigmoid(x)=xe^{x}/1+e^{x}.

Note that these are just some examples and many others are possible.

Accordingly, aspects described herein provide a technical solution to the technical problem of processing a wide variety of activation functions, such as those used with many machine learning model architectures, on a wide variety of devices despite inherent device capability limitations.

Compressing Activation Functions

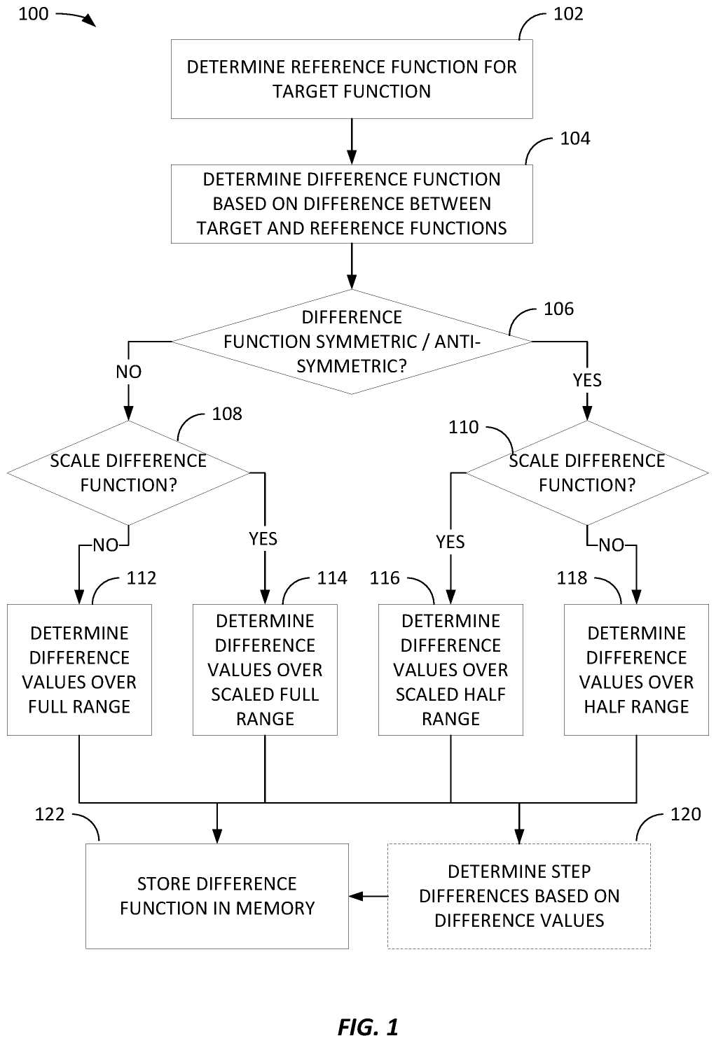

FIG. 1 depicts an example process 100 for compressing activation functions. Process 100 begins at step 102 with determining a reference function for a target function. In some cases, this determination may be based on a range of input values, such that a reference function that is very similar to a target function within the range, but not outside of the range, is still usable as a reference function.

In some cases, the reference function may be automatically selected based on comparing known reference functions to the target function over a range of input values and selecting the reference function with the least total difference, which may be measured by various metrics, such as mean squared error, L1-Norm, and others. In some cases, the reference function may be scaled and/or shifted prior to making this comparison. In some cases, a reference function may be selected such that the reference function requires minimal storage and recovery cost. For example, ReLU requires minimal storage because it can be calculated as a simple max operation, max(0, x). In some cases, a reference function may be selected such that it may be shared by multiple target activation functions in order to lower overall cost among a set of associated activation functions.

Process 100 then proceeds to step 104 with determining a difference function based on the difference between the target and reference functions over an input range. In some cases the difference function may be just a difference between the functions (e.g., diff=ƒₜ(x)−ƒᵣ(x)), where ƒₜ(x) is the target function for some input x and ƒᵣ(x) is the reference function for the same input. FIG. 3, as described in more detail below, depicts an example where the difference function is a simple difference between target and reference functions.

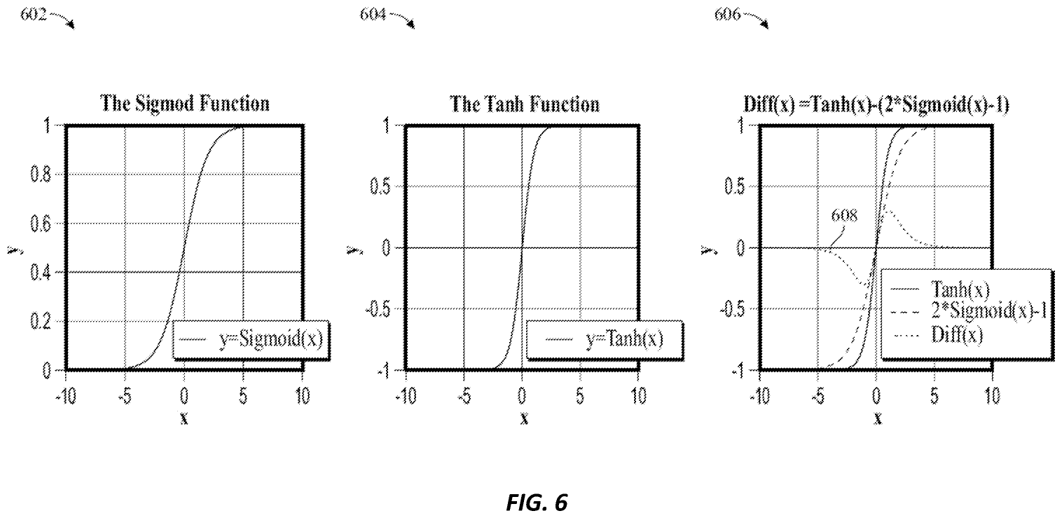

In other cases, the difference function may be more complex, and may include, for example, coefficients, constants, and the like. For example, FIG. 6, described further below, depicts an example of a difference function that includes scaling and shifting terms that cause the reference function to better “fit” the target function.

In either case, the difference function may be encoded over a quantized range of input values by determining difference values for each discrete reference point (e.g., input value) in the quantized range. The number of reference points (e.g., the degree of quantization) may be determined in some cases based on the level of compression desired for a particular application. The encoded difference function may then be stored in a memory, such as a look-up table, and referenced when reconstructing the target function. For inputs between reference points (e.g., between two input values), an interpolation may be performed in some cases, or the reference point closest to the input may be used. For inputs above or below the range, the nearest reference point value (e.g., at the end of the range closes to the input) may be used.

Process 100 then proceeds to step 106 where a determination is made whether the difference function is either symmetric or antisymmetric. Herein, antisymmetric means that a positive or negative input with the same absolute value results in an output of the same magnitude, but changed in sign.

If the difference function is neither symmetric nor antisymmetric, then process 100 moves to step 108 with determining whether to scale the difference function.

Difference function scaling generally allows for compressing/encoding a smaller interval of the difference function, e.g., scaled down by a factor of s. Then, during decompression/decoding, the scaling factor can be applied to bring the difference function back to full scale. Scaling may beneficially reduce the memory requirement for the compressed/encoded difference function by a factor of 1/s.

Difference function scaling is effective when such downscaling and upscaling introduce errors that do not exceed a configurable threshold, which may dynamically depend on the accuracy requirement of the target tasks.

If at step 108 the difference function is not to be scaled, then the difference values over a full range of input values are determined at step 112. If at step 108, the difference function is to be scaled, then the difference values over a scaled full range of input values are determined at step 114. As above, the input range over which the difference function is encoded may be configured based on the expected use case. For example, where an activation function is asymptotic, the range may be selected to encompass only output values with a magnitude greater than a threshold level.

If the difference function is symmetric or antisymmetric, then process 100 moves to step 110 with determining whether to scale the function according to the same considerations as described above.

If at step 110 the function is not to be scaled, then the difference values are determined over half a range at step 118. If at step 110, the function is to be scaled, then the difference values over a scaled half range of input values are determined at step 116.

Process 100 then optionally proceeds to step 120 with determining step differences based on difference function values determined in any one of steps 112, 114, 116, and 118. An example of determining step differences and then iteratively recovering a total difference is described with respect to FIG. 5.

Process 100 then proceeds to step 122 with storing a difference function based on the determined difference values (e.g., in steps 112, 114, 116, and 118) in a memory (e.g., to a look-up table). Generally, the difference function may be represented as a data type with a number of bits to represent values of the difference function. For example, each value of the difference function may be stored as an N-bit fixed-point data type or an M-bit floating-point data type, with N or M being a design choice based on the desirable numerical precision and the storage and processing costs.

Notably, process 100 is one example in order to demonstrate various considerations for how to compress a function, such as an activation function. Alternative processes (e.g., with alterative order, alternative steps, etc.) are possible.

Example Process for Decompressing and Using Decompressed Activation Functions

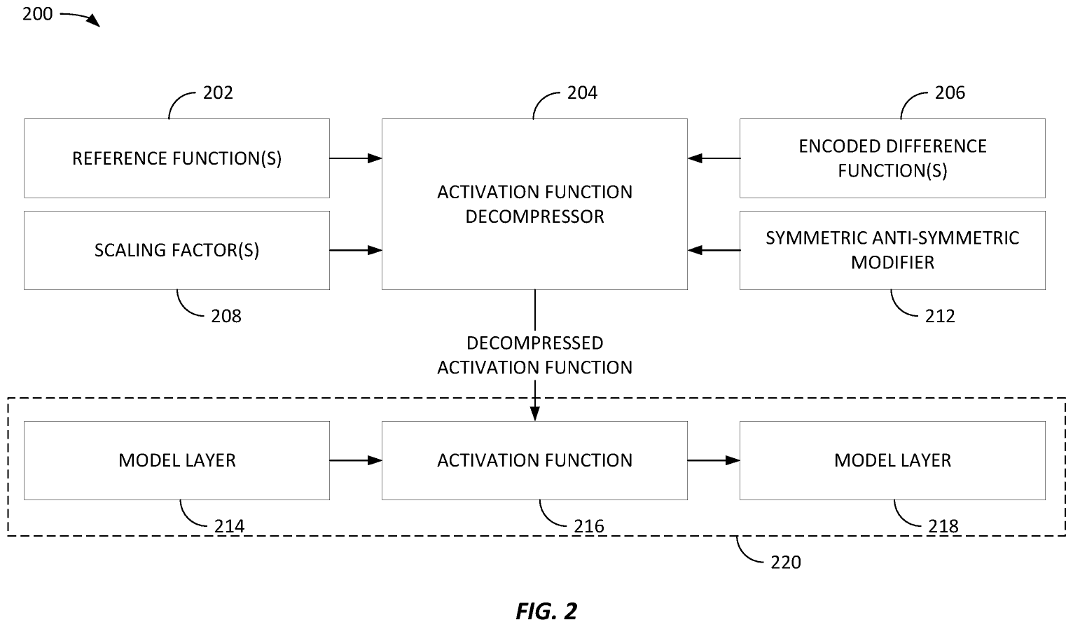

FIG. 2 depicts an example process 200 for decompressing and using decompressed functions, such as activation functions, within a machine learning model architecture.

Initially, a model (or model portion) 220 may include various layers (e.g., 214 and 218) and activation functions (e.g., activation function 216). For example, the output from model layer 214 may be activated by activation function 216, and the activations may then be used as input for model layer 218.

In some cases, it may be desirable to use a compressed activation function for activation function 216 (e.g., as a proxy for a target activation function), such as when model 220 is being processed on a lower power device. In such cases, activation function decompressor 204 may determine (or be preconfigured with) an appropriate reference function 202 for activation function 216 as well as an encoded difference function 206 associated with the selected reference function 202.

Note that in some cases, a reference function may be calculated at run-time, while in other cases, the reference function may be stored. For example, the reference function may be quantized and stored in a look-up table, such as with encoded difference functions 206.

Activation function decompressor 204 may further apply scaling factors 208 (e.g., when the encoded difference function 206 is scaled before storage, such as described with respect to steps 114 and 116 of FIG. 1) and symmetric or antisymmetric modifiers 212 when a partial range is stored (e.g., as describe with respect to steps 116 and 118 in FIG. 1). For example, a symmetric or antisymmetric modifier may flip the sign of an encoded difference value based on the input value to the decompressed activation function.

Activation function decompressor 204 may thus provide a decompressed activation function as a proxy for an original (e.g., target) activation function 216 of model architecture 200. As described above, the decompressed activation function may save significant processing complexity as compared to using the original target activation function.

In some cases, a model may include configurable alternative paths to use original activation functions or decompressed activation functions based on context, such as based on what type of device is processing the model, or the accuracy needs of the model based on a task or task context, and the like. In this way, existing model architectures may be enhanced with compressed activation functions that are selectably used based on conditions.

Example Difference Function Determination

FIG. 3 depicts an example of determining a difference function based on a target activation function and a reference activation function.

In particular, in FIG. 3. The target activation function, Swish, is depicted over an input range of −10 to 10 in chart 302. As above, Swish generally requires higher computational complexity owing to its multiplication, division, and exponential components.

The reference activation function in this example, ReLU, is depicted over the same input range of −10 to 10 in chart 304. Upon inspection, it is clear that ReLU is very similar to Swish across the depicted input range of values.

A difference function 308 is depicted in chart 306 and is based on the simple difference between the target activation function (Swish in this example, as in chart 302) and the reference activation function (ReLU in this example, as in chart 304). Accordingly, in this example, the difference function may be represented as:

Diff(x)=Swish(x)−ReLU(x)

Notably, difference function 308 has a significantly smaller dynamic range as compared to both the target activation function (as depicted in chart 302) and the reference activation function (as depicted in chart 304).

Accordingly, a machine learning model architecture may use a reconstructed/decompressed version of Swish according to \hat{T}(x)=ReLU(x)+Diff(x), where (x) is the decompressed version for the target activation function. Because, in this example, ReLU (computed as max(x, 0)) is significantly simpler computationally than Swish, the decompressed activation function may be used with little loss in fidelity, but significant savings in computational complexity.

Further, in this example, difference function 306 is symmetric about the reference point of x=0. As a proof of this, consider:

$$Diff ( x ) = S w i s h ( x ) - R e L U ( x ) Diff ( x ) = x {e}^{x} / 1 + {e}^{x} - max ( x , 0 ) For x > 0 : Diff ( x ) = \frac{x {e}^{x}}{1 + {e}^{x}} - x = \frac{x {e}^{x} - x ( 1 + {e}^{x} )}{1 + {e}^{x}} = \frac{- x}{1 + {e}^{x}} \qquad ( 1 )$$

$$For x = 0 : Diff ( x ) = 0 - 0 = 0 For x < 0 : Diff ( x ) = \frac{x {e}^{x}}{1 + {e}^{x}} - 0 = \frac{x {e}^{x}}{1 + {e}^{x}} \qquad ( 2 )$$

Now, assume ε>0. Plugging in x=ε into Equation 1 gives:

$$\frac{- ε}{1 + {e}^{ε}} . \qquad ( 3 )$$

Further, plugging in x=−ε into Equation 2 gives:

$$( 2 ) = \frac{- ε {e}^{- ε}}{1 + {e}^{- ε}} = \frac{- ε {e}^{- ε} {e}^{ε}}{{e}^{ε} + 1} = \frac{- ε}{1 + {e}^{ε}} = ( 3 )$$

In other words, Equation 1=Equation 2, which means Diff(x) is symmetric about x=0 and Diff(0)=0. Thus, only half of Diff(x) needs to be compressed/encoded, but the decoded/decompressed function can still cover the full range of input values.

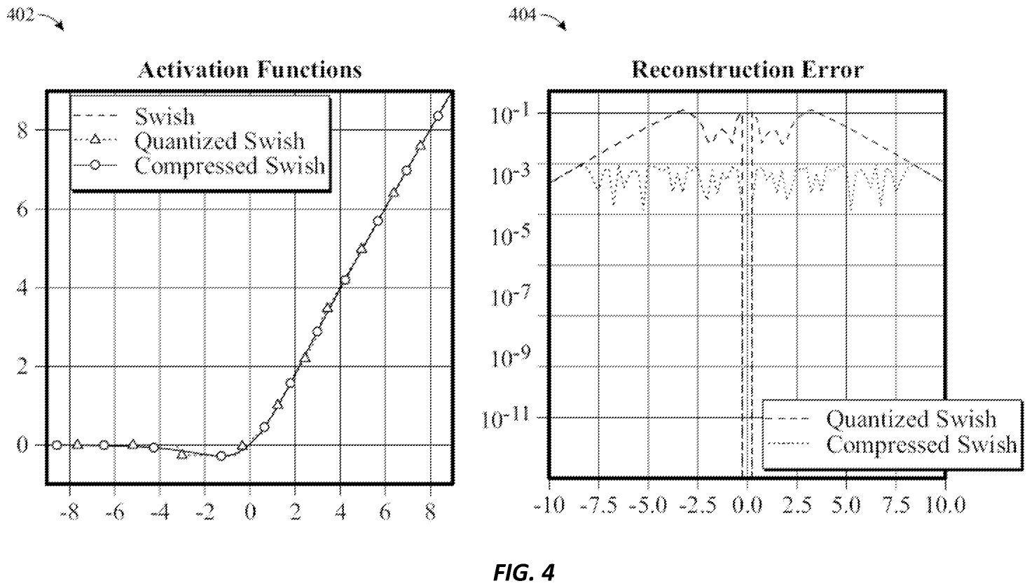

FIG. 4 depicts a comparison of a target activation function (Swish), a quantized target activation function, and a compressed target activation function.

In particular, chart 402 shows that Swish and compressed Swish, as described above by \hat{T}(x)=ReLU(x)+Diff(x), are nearly identical, and maintain lower error and a more true functional shape as compared to quantized Swish. Similarly, chart 404 shows the error when reconstructing Swish using compressed Swish versus quantized Swish, and it is clear that compressed Swish has lower reconstruction error.

Further, given the symmetric nature of the difference between Swish (target activation function) and ReLU (reference activation function), as described above, compressed Swish can be further compressed by storing only half its range, which beneficially allows significantly higher compression over naive quantized approaches while still maintaining lower reconstruction error.

Example Step Difference Function

FIG. 5 depicts an example of a determining a step difference function based on a difference function.

Returning to the example described with respect to FIGS. 3 and 4, a difference function 504 between Swish and ReLU may be defined as Diff(x)=Swish(x)−ReLU(x), which is symmetric about x=0. Thus only half of difference function 504 needs to be stored, because the other half is recoverable based on the symmetry. Thus, FIG. 5 depicts half of the input range for difference function 504 (where x>0) in chart 502.

Notably, even though the difference function 504 already has a much smaller dynamic range than the underlying target and reference activation functions, it is possible to further encode and compress the difference function by determining step (or incremental) differences between different points of difference function 504.

For example, consider a function y=Diff(x) for x={xᵢ}, i=0, 1, . . . n and for y={yᵢ}, i=0, 1, . . . n, then yᵢ=xᵢ₊₁−xᵢ. In other words, when decompressing (decoding) for yᵢ, the following iterative determination can be used to recover the function: xᵢ₊₁=xᵢ+yᵢ. Thus, the step difference function may be described as StepDiff(xᵢ)=Diff(xᵢ₊₁)−Diff(xᵢ).

FIG. 5 depicts an example of quantizing difference function 504 and storing it in a look-up table 508 (e.g., in a memory). The difference values stored in look-up table 508 are one example of an encoded difference function, such as 206 of FIG. 2. The encoded difference function may also be referred to as a differential or incremental encoding function.

Similarly, step difference function 506 may be quantized and stored in a look-up table 510. While both difference function 504 and step difference function 506 are depicted as stored in look-up tables, note that generally only one is necessary. For example, the Diff(x) value for D₁ can be reconstructed by summing StepDiff look-up table 510 values for the step differences: Δ_{0.5}, Δ₁, and Δ_{1.5}. Note that in this case the value of D1 is determined based on a sum of step differences starting from Δ_{0.5}, but in other examples, a different starting value may be used to anchor the iterative determination.

Further, the look-up table values for the step difference function 506 can be derived directly from difference function 504 without the need for intermediate determination of the difference values in look-up table 508. FIG. 5 is depicted in this manner to illustrate multiple concepts simultaneously.

In some cases, the quantization may be based on the underlying arithmetic processing hardware bitwidth. For example, when using an 8-bit processing unit, either of difference function 504 or step difference function 506 may be quantized with 256 values.

Example Antisymmetric Difference Function

FIG. 6 depicts an example of an anti symmetric difference function 608.

In this example, Tanh is a more computationally complex function than Sigmoid, thus Tanh is the target activation function and Sigmoid is the reference activation function. As above, to compress Tanh, a difference function can be encoded based on the difference between Tanh and Sigmoid over an input range.

Charts 602 and 604 show that Tanh and Sigmoid have globally similar shapes, but their individual output value ranges are different (between 0 and 1 for Sigmoid and between −1 and 1 for Tanh). To reduce the differences between them, Sigmoid (the reference function in this example) can be scaled and shifted so that its output range more closely matches to that of Tanh (the target function in this example). Thus, unlike the previous example with Swish and ReLu, where a simple difference was used, here a difference function between Tanh and Sigmoid uses coefficients and constants to shift and scale Sigmoid in order to further reduce the range of the encoded differences.

For example, here Diff(x) may be defined as:

Diff(x)=Tanh(x)−(2*Sigmoid(x)−1),

which is depicted in chart 606 at 608. Thus, the scaled and shifted reference activation function beneficially reduces the dynamic range of difference function 608 (Diff(x)).

Further, in this example difference function 608 is antisymmetric. To prove this, consider:

$$Diff ( x ) = Tanh ( x ) - ( 2 * sigmoid ( x ) - 1 ) = \frac{{e}^{2 x} - 1}{{e}^{2 x} + 1} - 2 * \frac{{e}^{x}}{{e}^{x} + 1} + 1 = \frac{{e}^{2 x} - 1}{{e}^{2 x} + 1} + \frac{- 2 {e}^{x} + {e}^{x} + 1}{{e}^{x} + 1} = \frac{{e}^{2 x} - 1}{{e}^{2 x} + 1} + \frac{1 - {e}^{x}}{1 + {e}^{x}} \qquad ( 4 )$$

Now, assuming ϵ>0 and plugging in x=ε and x=−ε, respectively:

$$x = ε for Equation 4 = \frac{{e}^{2 ε} - 1}{{e}^{2 ε} + 1} + \frac{1 - {e}^{ε}}{1 + {e}^{ε}} \qquad ( 5 )$$

$$x = - ε for Equation 4 = \frac{{e}^{- 2 ε} - 1}{{e}^{- 2 ε} + 1} + \frac{1 - {e}^{- ε}}{1 + {e}^{- ε}} = \frac{1 - {e}^{2 ε}}{1 + {e}^{2 ε}} + \frac{{e}^{ε} - 1}{{e}^{ε} + 1} \qquad ( 6 )$$

Then, defining

$$α {=}^{△} \frac{{e}^{2 ε} - 1}{{e}^{2 ε} + 1} and β {=}^{△} \frac{1 - {e}^{ε}}{1 + {e}^{ε}}$$

means that Equation 5=α+β and that:

$$( 6 ) = \frac{1 - {e}^{2 ε}}{1 + {e}^{2 ε}} + \frac{{e}^{ε} - 1}{{e}^{ε} + 1} = \frac{- {e}^{2 ε} + 1}{{e}^{2 ε} + 1} + \frac{- 1 + {e}^{ε}}{{e}^{ε} + 1} = - ( α + β ) = - ( 5 )$$

Therefore, Diff(x) is anti-symmetric such that Diff(−x)=−Diff(x). As above, this means that only on half of Diff(x) needs to be encoded and a simple negation operation can recover the other half.

Note that a step difference function based on difference function 608 could be further derived in the same manner as described above with the same benefits of further compressing the difference function.

Example Method for Compressing an Activation Function

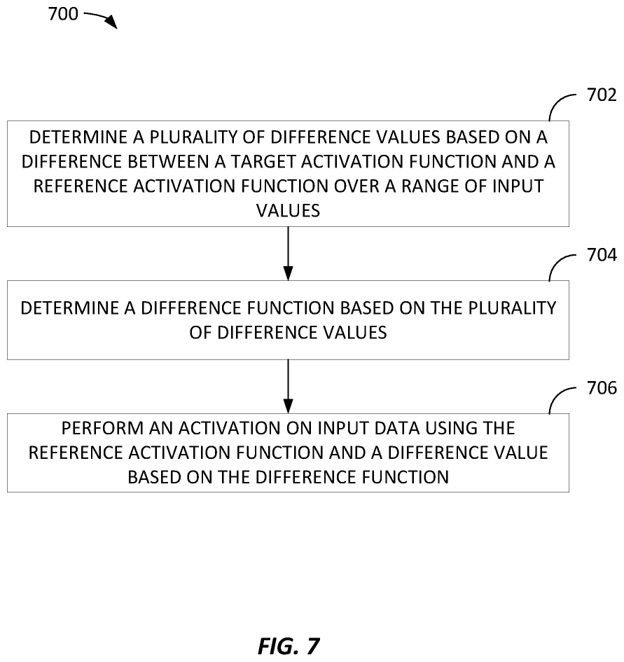

FIG. 7 depicts an example method 700 for compressing an activation function.

Method 700 begins at step 702 with determining a plurality of difference values based on a difference between a target activation function and a reference activation function over a range of input values.

Method 700 then proceeds to step 704 with determining a difference function based on the plurality of difference values.

In some aspects, the difference function includes one or more of a coefficient value for the reference activation function configured to scale the reference activation function and a constant value configured to shift the reference activation function, such as in the example depicted and described with respect to FIG. 6.

In some aspects, the difference function is symmetric about a reference input value, such as in the example described with respect to FIG. 3. In such cases, the subset of the plurality of difference values may occur on one side of the reference input value, such as depicted and described with respect to FIG. 5.

In some aspects, the difference function is antisymmetric about a reference input value, such as depicted and described with respect to FIG. 6. In such cases, the subset of the plurality of difference values may occur on one side of the reference input value. As above, an antisymmetric modifier such as discussed with respect to FIG. 2 can flip the sign of the difference based on an input value.

Method 700 then proceeds to step 706 with performing an activation on input data using the reference activation function and a difference value based on the difference function.

Though not depicted in FIG. 7, in some aspects, method 700 further includes storing the difference function to a memory. In one example, the difference function comprises a subset of the plurality of difference values, such as where the difference function is quantized and/or where the difference function represents only half a range due to symmetry or asymmetry of the difference function.

Method 700 may further include applying a scaling function to the subset of the plurality of difference values before storing them in the memory to reduce dynamic range of the subset of the plurality of difference values. In some cases, the scaling function may comprise a scaling factor. Generally, the scaling function may scale the range and/or the value of the function (e.g., the X-axis or Y-Axis in the examples depicted in FIGS. 3, 5, and 6).

Method 700 may further include determining a plurality of step difference values (e.g., step difference values stored in look-up table 510 in FIG. 5) based on the difference function, wherein each step difference value is the difference between two difference values (e.g., difference values stored in look-up table 508 in FIG. 5) in the plurality of difference values. In such cases, performing the activation on the input data may be further based on one or more step difference values of the plurality of step difference values.

Method 700 may further include determining a number of memory bits for storing each difference value in the subset of the plurality of difference values based on a dynamic range of the plurality of difference values. In some aspects, the number of memory bits is 8.

In some aspects, the target activation function is a non-symmetric function.

In some aspects, target activation function is a Swish activation function and the reference activation function is a ReLU function, such as described above with respect to FIGS. 3-5.

In some aspects, the target activation function is a Tanh activation function and the reference activation function is a Sigmoid activation function, such as described above with respect to FIG. 6.

In some aspects, the memory comprises a look-up table comprising the subset of the plurality of difference values. In some aspects, the look-up table comprises 256 entries for the difference function.

In some aspects, using the reference activation function comprises calculating the reference activation function. In other aspects, using the reference activation function comprises retrieving pre-computed reference function values from a memory.

Example Processing System

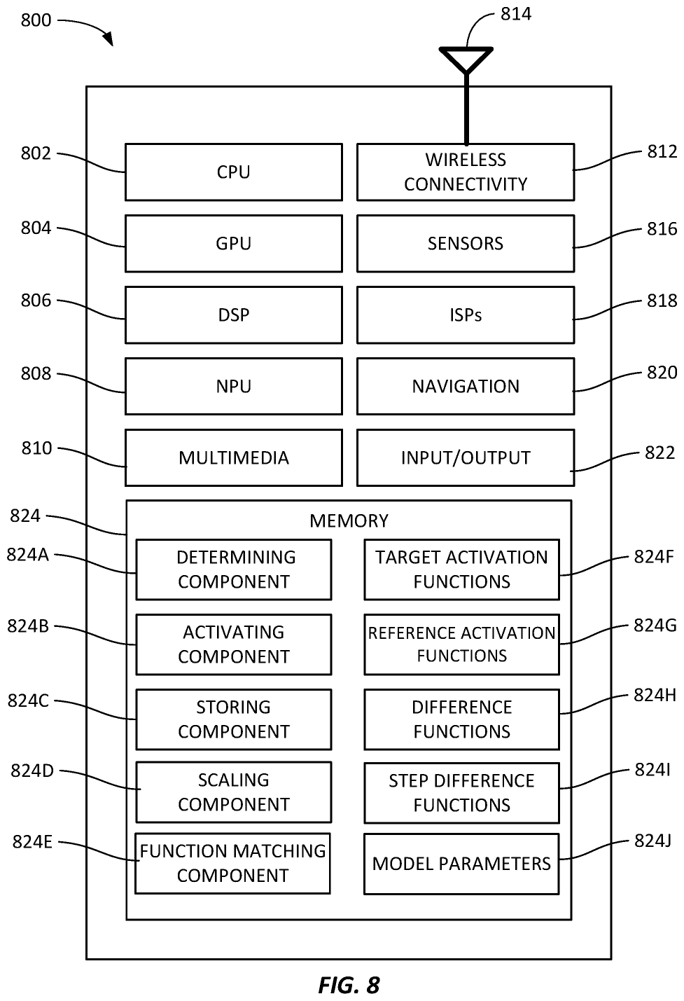

FIG. 8 depicts an example processing system 800 that may be configured to perform the methods described herein, such as with respect to FIG. 7.

Processing system 800 includes a central processing unit (CPU) 802, which in some examples may be a multi-core CPU. Instructions executed at the CPU 802 may be loaded, for example, from a program memory associated with the CPU 802 or may be loaded from memory 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

In some aspects, one or more of CPU 802, GPU 804, DSP 806, and NPU 808 may be configured to perform the methods described herein, such as with respect to FIG. 7.

An NPU, such as 808, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 808, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In some embodiments, NPU 808 may be implemented as a part of one or more of CPU 802, GPU 804, and/or DSP 806.

In some embodiments, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 812 is further connected to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned components of processing system 800.

In particular, in this example, memory 824 includes determining component 824A, activating component 824B, storing component 824C, scaling component 824D, function matching component 824E, target activation functions 824F, reference activation functions 824G, difference functions 824H, step difference functions 8241, and model parameters 824J (e.g., weights, biases, and other machine learning model parameters). One or more of the depicted components, as well as others not depicted, may be configured to perform various aspects of the methods described herein.

Generally, processing system 800 and/or components thereof may be configured to perform the methods described herein.

Notably, in other embodiments, aspects of processing system 800 may be omitted, such as where processing system 800 is a server computer or the like. For example, multimedia component 810, wireless connectivity 812, sensors 816, ISPs 818, and/or navigation component 820 may be omitted in other embodiments. Further, aspects of processing system 800 maybe distributed.

Note that FIG. 8 is just one example, and in other examples, alternative processing system with fewer, additional, and/or alternative components may be used.

### Example Clauses

Implementation examples are described in the following numbered clauses:

Clause 1: A method, comprising: determining a plurality of difference values based on a difference between a target activation function and a reference activation function over a range of input values; determining a difference function based on the plurality of difference values; and performing an activation on input data using the reference activation function and a difference value based on the difference function.

Clause 2: The method of Clause 1, further comprising storing the difference function in a memory as a subset of the plurality of difference values.

Clause 3: The method of Clause 2, wherein the difference function is stored as a subset of the plurality of difference values.

Clause 4: The method of any one of Clauses 1-3, wherein the difference function includes a coefficient value for the reference activation function configured to scale the reference activation function.

Clause 5: The method of Clause 4, wherein the difference function includes a constant value configured to shift the reference activation function.

Clause 6: The method of any one of Clauses 2-5, wherein: the difference function is symmetric about a reference input value, and the subset of the plurality of difference values occurs on one side of the reference input value.

Clause 7: The method of any one of Clauses 2-5, wherein: the difference function is antisymmetric about a reference input value, and the subset of the plurality of difference values occurs on one side of the reference input value.

Clause 8: The method of any one of Clauses 2-7, further comprising applying a scaling function to the subset of the plurality of difference values before storing them in the memory to reduce dynamic range of the subset of the plurality of difference values.

Clause 9: The method of any one of Clauses 1-8, further comprising: determining a plurality of step difference values based on the difference function, wherein each step difference value is determined as a difference between two difference values in the plurality of difference values, wherein performing the activation on the input data is further based on one or more step difference values of the plurality of step difference values.

Clause 10: The method of any one of Clauses 2-9, further comprising determining a number of memory bits for storing each difference value in the subset of the plurality of difference values based on a dynamic range of the plurality of difference values.

Clause 11: The method of Clause 10, wherein the number of memory bits is 8.

Clause 12: The method of any one of Clauses 1-11, wherein the target activation function is a non-symmetric function.

Clause 13: The method of any one of Clauses 1-12, wherein the target activation function is a Swish activation function and the reference activation function is a ReLU function.

Clause 14: The method of any one of Clauses 1-13, wherein the target activation function is a Tanh activation function and the reference activation function is a Sigmoid activation function.

Clause 15: The method of any one of Clauses 2-14, wherein the memory comprises a look-up table comprising the subset of the plurality of difference values.

Clause 16: The method of Clause 15, wherein the look-up table comprises 256 entries for the difference function.

Clause 17: The method of any one of Clauses 1-16, wherein using the reference activation function comprises calculating the reference activation function.

Clause 18: The method of any one of Clauses 1-17, wherein using the reference activation function comprises retrieving pre-computed reference function values from a memory.

Clause 19: A processing system, comprising: a memory comprising computer-executable instructions; one or more processors configured to execute the computer-executable instructions and cause the processing system to perform a method in accordance with any one of Clauses 1-18.

Clause 20: A processing system, comprising means for performing a method in accordance with any one of Clauses 1-18.

Clause 21: A non-transitory computer-readable medium comprising computer-executable instructions that, when executed by one or more processors of a processing system, cause the processing system to perform a method in accordance with any one of Clauses 1-18.

Clause 22: A computer program product embodied on a computer-readable storage medium comprising code for performing a method in accordance with any one of Clauses 1-18.

Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
determining a plurality of difference values based on a difference between a target activation function and a reference activation function over a range of input values;
determining a difference function based on the plurality of difference values; and
performing an activation on input data using the reference activation function and a difference value based on the difference function.

2. The method of claim 1, further comprising storing the difference function in a memory as a subset of the plurality of difference values.

3. The method of claim 2, wherein the difference function is stored as a subset of the plurality of difference values.

4. The method of claim 1, wherein the difference function includes a coefficient value for the reference activation function configured to scale the reference activation function.

5. The method of claim 4, wherein the difference function includes a constant value configured to shift the reference activation function.

6. The method of claim 2, wherein:
the difference function is symmetric about a reference input value, and the subset of the plurality of difference values occurs on one side of the reference input value.

2. The method of claim 2, wherein:
the difference function is antisymmetric about a reference input value, and the subset of the plurality of difference values occurs on one side of the reference input value.

8. The method of claim 2, further comprising applying a scaling function to the subset of the plurality of difference values before storing them in the memory to reduce dynamic range of the subset of the plurality of difference values.

9. The method of claim 1, further comprising:
determining a plurality of step difference values based on the difference function, wherein each step difference value is determined as a difference between two difference values in the plurality of difference values,
wherein performing the activation on the input data is further based on one or more step difference values of the plurality of step difference values.

10. The method of claim 2, further comprising determining a number of memory bits for storing each difference value in the subset of the plurality of difference values based on a dynamic range of the plurality of difference values.

11. The method of claim 10, wherein the number of memory bits is 8.

12. The method of claim 1, wherein the target activation function is a non-symmetric function.

13. The method of claim 1, wherein the target activation function is a Swish activation function and the reference activation function is a ReLU function.

14. The method of claim 1, wherein the target activation function is a Tanh activation function and the reference activation function is a Sigmoid activation function.

15. The method of claim 2, wherein the memory comprises a look-up table comprising the subset of the plurality of difference values.

16. The method of claim 15, wherein the look-up table comprises 256 entries for the difference function.

17. The method of claim 1, wherein using the reference activation function comprises calculating the reference activation function.

18. The method of claim 1, wherein using the reference activation function comprises retrieving pre-computed reference function values from a memory.

19. A processing system, comprising:
one or more memories comprising computer-executable instructions; and
one or more processors configured to execute the computer-executable instructions and cause the processing system to:
determine a plurality of difference values based on a difference between a target activation function and a reference activation function over a range of input values;
determine a difference function based on the plurality of difference values; and
perform an activation on input data using the reference activation function and a difference value based on the difference function.

20. The processing system of claim 19, wherein the one or more processors are further configured to cause the processing system to store the difference function in at least one of the one or more memories as a subset of the plurality of difference values.

21. The processing system of claim 20, wherein the difference function is stored as a subset of the plurality of difference values.

22. The processing system of claim 19, wherein the difference function includes a coefficient value for the reference activation function configured to scale the reference activation function.

23. The processing system of claim 22, wherein the difference function includes a constant value configured to shift the reference activation function.

24. The processing system of claim 20, wherein:
the difference function is symmetric about a reference input value, and the subset of the plurality of difference values occurs on one side of the reference input value.

25. The processing system of claim 20, wherein:
the difference function is antisymmetric about a reference input value, and the subset of the plurality of difference values occurs on one side of the reference input value.

26. The processing system of claim 20, wherein the one or more processors are further configured to cause the processing system to apply a scaling function to the subset of the plurality of difference values before storing them in at least one of the one or more memories to reduce dynamic range of the subset of the plurality of difference values.

27. The processing system of claim 19, wherein the one or more processors are further configured to cause the processing system to:
determine a plurality of step difference values based on the difference function, wherein each step difference value is determined as a difference between two difference values in the plurality of difference values,
wherein performing the activation on the input data is further based on one or more step difference values of the plurality of step difference values.

28. The processing system of claim 20, wherein the one or more processors are further configured to cause the processing system to determine a number of memory bits for storing each difference value in the subset of the plurality of difference values based on a dynamic range of the plurality of difference values.

29. The processing system of claim 28, wherein the number of memory bits is 8.

30. The processing system of claim 19, wherein the target activation function is a non-symmetric function.

31. The processing system of claim 19, wherein the target activation function is a Swish activation function and the reference activation function is a ReLU function.

32. The processing system of claim 19, wherein the target activation function is a Tanh activation function and the reference activation function is a Sigmoid activation function.

33. The processing system of claim 20, wherein the at least one of the one or more memories comprises a look-up table comprising the subset of the plurality of difference values.

34. The processing system of claim 33, wherein the look-up table comprises 256 entries for the difference function.

35. The processing system of claim 19, wherein in order to use the reference activation function, the one or more processors are further configured to cause the processing system to calculate the reference activation function.

36. The processing system of claim 19, wherein in order to use the reference activation function, the one or more processors are further configured to cause the processing system to retrieve pre-computed reference function values from at least one of the one or more memories.

37. A non-transitory computer-readable medium comprising computer-executable instructions that, when executed by one or more processors of a processing system, cause the processing system to perform a method, the method comprising:
determining a plurality of difference values based on a difference between a target activation function and a reference activation function over a range of input values;
determining a difference function based on the plurality of difference values; and
performing an activation on input data using the reference activation function and a difference value based on the difference function.

38. A processing system, comprising:
means for determining a plurality of difference values based on a difference between a target activation function and a reference activation function over a range of input values;
means for determining a difference function based on the plurality of difference values; and
means for performing an activation on input data using the reference activation function and a difference value based on the difference function.
